(19) United States
(12) Patent Application Publication
(10) Pub. No.: US 2025/0273702 A1
(43) Pub. Date: Aug. 28, 2025

(54) BIPOLAR PLATE OF FUEL CELL AND METHOD FOR OPERATING IT

(71) Applicant: ZEROAVIA, INC., Hollister, CA (US)

(72) Inventors: Sergei Shubenkov, Moscow (RU); Sergei Panov, Rybinsk (RU); Ilya Kosarev, Dolgoprudniy (RU); Dmitry Putintsev, Moscow (RU)

(73) Assignee: ZEROAVIA, INC., Hollister, CA (US)

(21) Appl. No.: 18/858,244

(22) PCT Filed: Apr. 18, 2022
(86) PCT No.: PCT/US2022/025162

§ 371 Date: Oct. 18, 2024

(51) Int. Cl. H01M 8/0267; H01M 8/0206; H01M 8/0258; H01M 8/04014

(52) U.S. Cl. CPC H01M 8/0267; H01M 8/0206; H01M 8/0258; H01M 8/04014

(57) ABSTRACT

Bipolar plates having two short sides, and two long sides for air-cooled fuel cells. The bipolar plate comprises an anode plate, a cathode plate, and an anode gas inlet an anode gas outlet. The anode plate and the cathode plate are connected to each other so that gaseous heat carrier distribution channels are formed therebetween such that, when a gaseous heat carrier is supplied, a time period through a hal of the bipolar plate near to the edge of the first long side is less than a time period through a half of the bipolar plate near to the edge of the second long side. The technical effect of the proposed invention is a reduced consumption of cooling air, reduced power consumption, dimensions and weight of a fuel cell cooling system, improved uniformity of bipolar plate cooling, which results in increased capacity and a longer service life of a fuel cell.

### FIELD OF THE INVENTION

The proposed invention relates to bipolar plates of a fuel cell with cooling by means of a gaseous heat carrier, and to methods of operating them.

The invention is applicable both for stationary systems of fuel cells and for fuel cell plants intended for transportation vehicles, in particular for aviation in a wide range of altitudes.

The use of the invention layout is most preferable when a temperature difference between cooling gas at the inlet and a fuel cell, a portion of which being formed by the bipolar plate, is more than 50° C.; it may be used, for example, in a fuel cell disclosed in U.S. patent application Ser. No. 17/168,926.

### DESCRIPTION OF PRIOR ART

Fuel cells are electrochemical devices that may transform chemical energy of a fuel into electric energy highly efficiently.

A bipolar plate is a component of a fuel cell, wherein chemical energy is transformed into electric power; it ensures electric contact, supply of reactant gases (cathode gas and anode gas) and cooling of a fuel cell.

US patent for invention 9,853,300 B2, published on 26 Dec. 2017, describes a bipolar plate including an anode plate and a cathode plate with coolant channels formed therebetween. Since the inlet and outlet holes are located at edge portions of a reaction region, air and hydrogen flow in directions perpendicular to each other. Coolant flows from one short side of the plate to the other short side along a zigzag path.

A disadvantage of this bipolar plate is that it is not suited for air cooling. Due to the fact that coolant flows from one short side of the plate to the other short side along a zigzag path, a coolant path in the plate is rather lengthy, which evidences that a liquid, rather than air, may be used as coolant, since air, due to its low volumetric specific heat capacity in this configuration, would lose its cooling properties and would not provide efficient cooling of the plate. In such a plate, quick heating of gaseous coolant (due to its low heat capacity), while it moves along the plate, would result in poorer heat removal from the plate, and a distant portion of the plate would not be cooled or would be cooled rather poorly. It would lead to quick failure of the fuel cell because of a high degree of its non-uniform cooling. Furthermore, due to a long path of coolant and its considerable volumetric flow rates for cooling, a considerable gas-dynamic flow resistance would appear, and, consequently, great power inputs would be required for pumping gaseous coolant that would be, possibly, comparable to useful power produced by the fuel cell.

CN patent for utility model #210576224U, published on 19 May 2020, discloses a fuel cell comprising a bipolar plate which consists of an anode plate and a cathode plate welded therebetween. The cathode plate has triangular air channels with through holes that are produced by extruding a corrugated plate in the direction transverse to the corrugations. Forcibly convected air passes along the air channels, removing, on one side, by-product heat from the fuel cell and providing, on the other side, oxygen required for the electrochemical reaction at the cathode. The air and oxygen flows are perpendicular to each other, and air passing to the cathode is used for cooling.

A disadvantage of this bipolar plate is the absence of separate cooling channels, which presupposes that only uncompressed air may be used for the electrochemical reaction; this negatively affects dimensions, specific power per unit weight, and power efficiency of the fuel cell. Compression of the cathode air is justified from the energy point, since it enables the fuel cell to produce additional power that is greater than power required for compression of the cathode air. At the same time, compression of air for cooling requires very high power inputs due to high consumption of cooling air, and the structure disclosed in this patent does not enable to get benefits from compression of air used both for the reaction and for cooling simultaneously.

As the closest analog, a bipolar plate, as disclosed in the CN patent application #112436163A published on 2 Mar. 2021, may be taken. The metal bipolar plate for a fuel cell comprises an anode plate, an air cooling plate and a cathode plate which are sequentially connected, wherein the anode plate and the air cooling plate are welded to form a single body and combined with the cathode plate. The anode plate has a channel for a fuel gas (hydrogen) flow on the side that is opposite to the air cooling plate; and the cathode plate has a channel for a reaction air flow on the side that is opposite to the air cooling plate. The two sides of the cooling plate are provided with channels for a cooling air flow.

A disadvantage of this bipolar plate is a high flow rate of cooling air, since it does not consider peculiarities of air as coolant with low heat capacity, where such a flow rate requires that a cooling system with great dimensions and weight should be used. Further, the bipolar plate structure with three separate plates causes a considerable increase in bipolar plate weight and dimensions as compared to a structure made of two plates.

### SUMMARY OF THE INVENTION

The object of the present invention is to overcome drawbacks of the technical solutions known in the art, reduce consumption of cooling air or another gaseous heat carrier, reduce weight and dimensions of fuel cell cooling system and the bipolar plate itself, increase power capacity and service life of a fuel cell comprising the bipolar plate.

The technical effect of the proposed invention is a reduced consumption of cooling (or heating at the step of pre-heating) air or another gaseous heat carrier, reduced dimensions and weight of a fuel cell cooling (or heating) system, reduced power consumption for cooling, improved uniformity of bipolar plate cooling (or heating), resulting in increased capacity and a longer service life of a fuel cell comprising the proposed bipolar plate.

To solve this task and achieve the technical effect, a fuel cell bipolar plate is proposed that has two short sides and two long sides and comprises an anode plate having an inlet for anode gas, an outlet for anode gas and anode gas channels, and a cathode plate having an inlet for cathode gas, an outlet for cathode gas and cathode gas channels,
wherein
the anode gas channels are made so that the inlet for anode gas is near the edge of one short side of the bipolar plate, and the outlet for anode gas is near the edge of the other short side of the bipolar plate,
the cathode gas channels are made so that the inlet for cathode gas is near the edge of one short side of the bipolar plate, and the outlet for cathode gas is near the edge of the other short side of the bipolar plate,
the anode plate and the cathode plate are connected to each other so that gaseous heat carrier distribution channels are formed therebetween, which inlets are near the edge of a first long side A1 of the bipolar plate, and which outlets are near the edge of a second long side A2 of the bipolar plate,
and wherein
the gaseous heat carrier distribution channels are formed so that, when a gaseous heat carrier is supplied, a time period for which it passes a half of the bipolar plate near to the edge of the first long side A1 is less than a time period for which it passes a half of the bipolar plate near to the edge of the second long side A2 of the bipolar plate.

The bipolar plate may be manufactured by any possible methods, such as etching, stamping, rolling, etc.

Individual elements of the bipolar plate may be connected to each other by any possible methods, such as brazing, gluing, welding, etc.

The gaseous heat carrier distribution channels are oriented, mainly, along a short side of a fuel cell and may have a certain cross-section, e.g. rectangular, trapezoidal, semi-circular, circular, polygonal, etc.

Manufacturing of the bipolar plate from two sheets: the cathode plate and the anode plate, significantly simplifies production and reduces weight of the bipolar plate as a whole.

The cathode plate and the anode plate are provided with channels for a cathode gas and an anode gas, respectively.

A gaseous fuel, e.g. hydrogen or a hydrogen-containing gas, may be used as the anode gas; and air or another oxygen-containing gas, oxygen, a mixture of oxygen with one or more gases may be used as the cathode gas; air or another available gas may be used as the gaseous heat carrier.

The anode gas channels are covered from above by a membrane-electrode assembly (MEA), namely, directly by a gas-diffusion layer (GDL) of the MEA.

The cathode gas channels are covered by a GDL of the next MEA.

The cathode gas and the anode gas pass along the outer sides of the bipolar plate in the direction from an inlet (manifold) to the outlet mainly along long edges of the plate.

The gaseous heat carrier passes along the channels formed between the two plates, mainly in the direction perpendicular to the movement of the cathode gas and the anode gas.

The gaseous heat carrier is intended for cooling or heating the bipolar plate, depending on what is required for maintaining operation of the fuel cell at the moment.

The arrangement of the inlets/outlets for the anode gas and the cathode gas near the opposite edges of the bipolar plate short sides facilitates passage of the anode gas and the cathode gas over the whole surface of the bipolar plate in order to provide conditions for effective conduction of the electrochemical reaction.

The arrangement of the inlets/outlets for distribution of the gaseous heat carrier near the edges of the long sides of the bipolar plate enables to form a short path for a gaseous heat carrier flow in order to take into account low heat capacity of air and use it with maximum efficiency for uniform cooling or heating the bipolar plate, and also to reduce a gas-dynamic resistance of the cooling flow and, consequently, power inputs for pumping the heat carrier.

As compared to a liquid heat carrier, a gaseous heat carrier has a lower specific volumetric heat capacity, therefore, its temperature can be equalized with temperatures of surrounding objects quicker; and for this reason gaseous heat carrier distribution channels should be shorter than channels for a liquid heat carrier.

Due to that, when a gaseous heat carrier is supplied, a time period of its passage along the half of the bipolar plate near to the edge of the first long side A1 (the first half) will be less than a time period of its passage along the half of the bipolar plate near to the edge of the second long side A2 of the bipolar plate (the second half), uniform cooling (or heating) of the bipolar plate is achieved, which increases power and prolongs the service life of a fuel cell comprising the bipolar plate.

In the beginning of its path, cooling air (gaseous heat carrier) is not yet heated by the plate surface; and, therefore, even with quick passage along the first half of the plate, it has enough time for cooling (heating) it sufficiently, and the air enters the second half of the plate already more heated (cooled); therefore, a longer time, required for passing the second half of the plate, enables to increase efficiency of heat removal as the cooling air passes inside the bipolar plate.

This helps to achieve great temperature uniformity inside the fuel cell with a considerable temperature gradient within the heat carrier flow, which, as a result, enables to significantly reduce consumption of the gaseous heat carrier and, correspondingly, a weight, volume and power consumption of the cooling system, which is most important for high-capacity fuel cell systems.

If a time period of passing the first half of the plate by a gaseous heat carrier is greater or equal to a time period of its passing the second half of the plate, then the first half of the plate will be cooled more than the second half, which will cause a great temperature gradient in the bipolar plate and, consequently, in the fuel cell comprising the bipolar plate. This, in its turn, will decrease power and increase degradation of the fuel cell.

Particular time periods of passing through the first half and the second half of the bipolar plate can be chosen experimentally or by mathematic modeling while proceeding from a particular structure of the bipolar plate, a material it is made of, a specific heat capacity and a density of a gaseous heat carrier so as to achieve uniform cooling (heating) of the bipolar plate.

Preferably, the bipolar plate has substantially rectangular shape, trapezoidal shape or the shape of a ring sector, since this shape enables to further reduce consumption of a gaseous heat carrier required for uniform cooling of the bipolar plate.

Preferably, the gaseous heat carrier distribution channels include B1 channels extending from the edge of the first long side A1 of the bipolar plate to the edge of the second long side A2 of the bipolar plate, and B2 channels communicating with B1 channels, wherein B2 channels are substantially parallel to the long sides of the bipolar plate.

The availability of the two types of gaseous heat carrier distribution channels, i.e. the longitudinal B1 channels (along the main passage of a gaseous heat carrier) and the transversal B2 channels (transverse the main passage of cooling air and along the channels for the anode and cathode gases) enables to manage the movement trajectory and the passage time period of a gaseous heat carrier along its movement and, thus, improve efficiency of cooling the bipolar plate by the gaseous heat carrier.

The transverse channels may be formed, for example, by back sides of the channels for the anode gas and the cathode gas, and the longitudinal channels are formed by changing depths of the channels for the anode gas and the cathode gas, the depths of the channels for the anode gas and the cathode gas being changed due to crossing the longitudinal cooling channels and being partially covered by them.

Preferably, a cross-sectional area of the B1 channels is increased in the direction from the edge of the first long side A1 of the bipolar plate to the edge of the second long side A2 of the bipolar plate, which also enables to manage efficiency of heat removal by a gaseous heat carrier along its path (by means of slowing down gas flow) and, thus, decrease non-uniformity of temperature distribution along the surface of the bipolar plate.

Preferably, the B1 channels comprise regions having obstacles made so as to deflect a part of a gaseous heat carrier flow from an initial direction of its movement for passing through the B2 channels, wherein the part of a gaseous heat carrier flow, which is deflected from the initial direction, being increased in the direction toward the edge of the second long side A2 of the bipolar plate.

The above channel structure also enables to manage efficiency of heat removal by a gaseous heat carrier along the direction of its movement, and, thus, decrease non-uniformity of temperature distribution along the surface of the bipolar plate.

Preferably, the above-mentioned regions are made so as to form a deflection of the part of a gaseous heat carrier flow from an initial direction of its movement, wherein the deflection being increased toward the edge of the second long side A2 of the bipolar plate, which also enables to manage efficiency of heat removal by cooling air along the direction of its movement, and, thus, decrease non-uniformity of temperature distribution along the surface of the bipolar plate.

Preferably, B3 channels are located between the B1 channels; they have their outlets near the edge of the second long side A2 of the bipolar plate, but do not have their own inlets near the edge of the first long side A1 of the bipolar plate, and they are substantially parallel to the short sides of the bipolar plate, the B3 channels communicating to the B1 channels via the B2 channels, which also enables to manage efficiency of heat removal by a gaseous heat carrier along the direction of its movement, and, thus, decrease non-uniformity of temperature distribution along the surface of the bipolar plate.

Preferably, a cross-sectional area of the B3 channels is increased toward the edge of the second long side A2 of the bipolar plate, which also enables to manage efficiency of heat removal by a gaseous heat carrier along the direction of its movement, and, thus, decrease non-uniformity of temperature distribution along the surface of the bipolar plate.

Preferably, a distance between the B1 channels is decreased in the direction from the edge of the first long side A1 of the bipolar plate to the edge of the second long side A2 of the bipolar plate, wherein the bipolar plate has substantially trapezoidal shape or the shape of a ring sector, which also enables to manage efficiency of heat removal by a gaseous heat carrier along the direction of its movement, and, thus, decrease non-uniformity of temperature distribution along the surface of the bipolar plate.

Preferably, inserts are arranged in the B1 channels, the inserts prevent at least a part of a gaseous heat carrier flow from passing through the B2 channels in the half of the bipolar plate near to the edge of the first long side A1.

These inserts are also used for laminarizing a gaseous heat carrier flow and ensuring its quicker passing through this region as well as for reducing a general resistance pressure, which also enables to manage efficiency of heat removal by a gaseous heat carrier along the direction of its movement, and, thus, decrease non-uniformity of temperature distribution along the surface of the bipolar plate.

Preferably, the anode plate and the cathode plate are made of a material having heat conductivity of at least 100 W/(m·K), preferably at least 125 W/(m·K), preferably of aluminium, magnesium, beryllium alloys, or of composite materials based on graphite films, carbon fibers or graphene.

The making the anode plate and the cathode plate of materials having high heat conductivity (magnesium heat conductivity is 125 W/(m·K), aluminium heat conductivity is 203.5 W/(m·K), beryllium heat conductivity is 201 W/(m·K), graphene heat conductivity is 2,000-5,000 W/(m·K)) enables to further improve uniformity of temperature distribution along the surface of the bipolar plate when it is cooled (or heated) by a gaseous heat carrier, which results in increasing power and prolonging the service life of a fuel cell and, also, to decrease a number of channels for cooling, which enables to further decrease weight and dimensions of the bipolar plate.

Further, to solve the above task and achieve the above technical effect, a method for operating the bipolar plate is proposed, wherein
a gaseous fuel is supplied to the channels for the anode gas;
an oxygen-containing mixture is supplied to the channels for the cathode gas; and
a gaseous heat carrier is supplied to the gaseous heat carrier distribution channels.

Preferably, the gaseous heat carrier is supplied to the gaseous heat carrier distribution channels under an absolute pressure from 25 kPa to 500 kPa; a gaseous heat carrier temperature difference between the inlet and the outlet of the bipolar plate is more than 50° C., and a gaseous heat carrier pressure difference on the bipolar plate is from 0.5 to 5 kPa, which enables to keep a gaseous heat carrier volumetric flowrate low, and, at a pressure difference in the above range, keep power inputs for pumping the heat carrier at a low level also.

When an absolute pressure of a gaseous heat carrier is less than 25 kPa and a gaseous heat carrier pressure difference on the bipolar plate is less than 0.5 kPa, it is very difficult to achieve a required flowrate of a heat carrier for effective cooling/heating of the bipolar plate, and a flow section of the cooling channels is to be increased considerably, which results in an appreciable increase in weight and dimensions of the bipolar plate.

A gaseous heat carrier absolute pressure above 500 kPa and a gaseous heat carrier pressure difference on the bipolar plate more than 5 kPa are unreasonable, since they would require significant power inputs for pumping the heat carrier, additional strengthening and weight increase of the bipolar plate.

### BRIEF DESCRIPTION OF THE DRAWINGS

The drawings are provided for better understanding of the invention; however, a person skilled in the art would appreciate that the invention, as disclosed, is not limited by the embodiments shown therein.

FIG. 1 shows a general view of the bipolar plate in accordance with the present invention.

FIG. 2 shows a general scheme of gas movements inside and along the bipolar plate.

FIG. 3 shows a frontal view of the longitudinal and transversal cooling channels.

FIG. 4 shows a cross-sectional view of a bipolar plate portion.

FIG. 5 shows an example of a bipolar plate portion with a trapezoidal shape of the active surface according to Embodiment 2 of the invention.

FIG. 6 shows an example of the bipolar plate with increasing number of the longitudinal channels according to Embodiment 3 of the invention.

FIG. 7 shows an example of the bipolar plate portion according to Embodiment 1 of the invention.

FIG. 8 presents, as an example, data on heating temperatures of the bipolar plate according to Embodiment 1 of the invention, when it is cooled with air having the inlet temperature of +55° C. and the outlet temperature of +170° C.

FIG. 9 presents data on velocity of cooling air and shows a scheme of its movement in the gaseous heat carrier distribution channels according to Embodiment 1 of the invention.

FIG. 10 shows an example of channels arrangement in the bipolar plate portion with a trapezoidal shape of the active surface and increasing number of the longitudinal channels according to Embodiment 3 of the invention.

### DESCRIPTION OF PREFERRED EMBODIMENTS OF THE INVENTION

### Embodiment 1

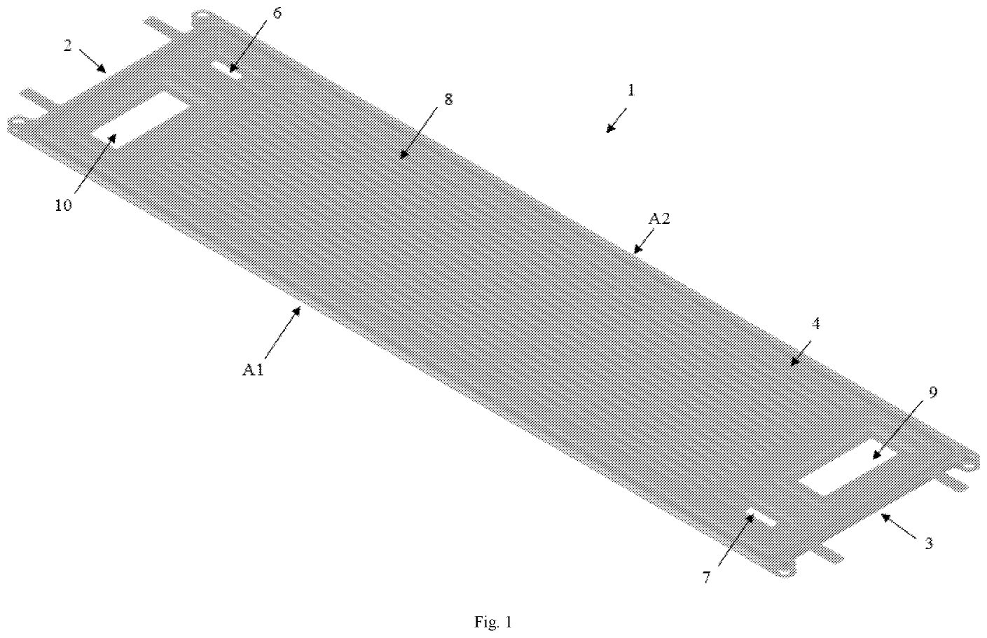

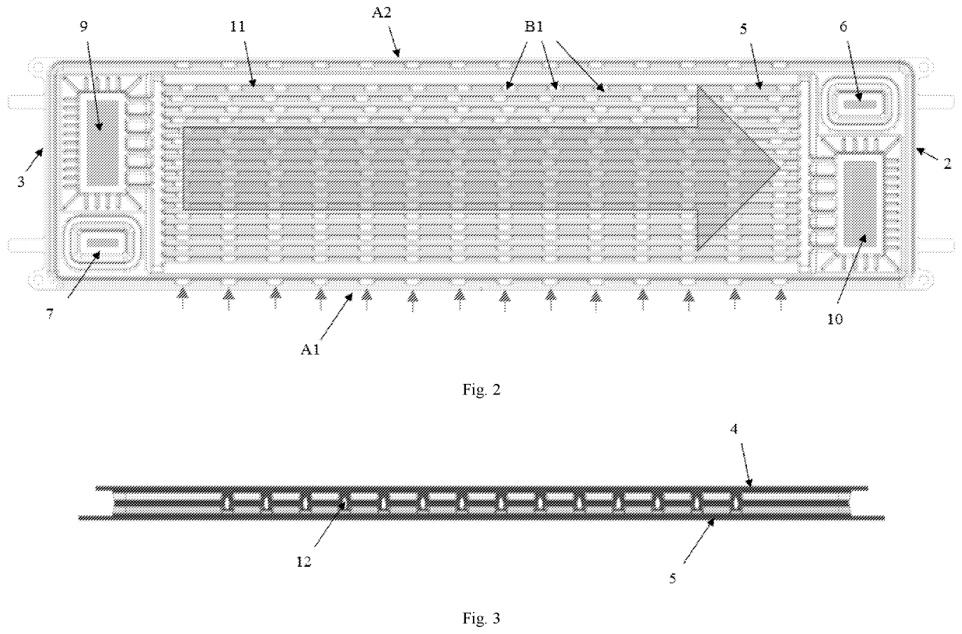

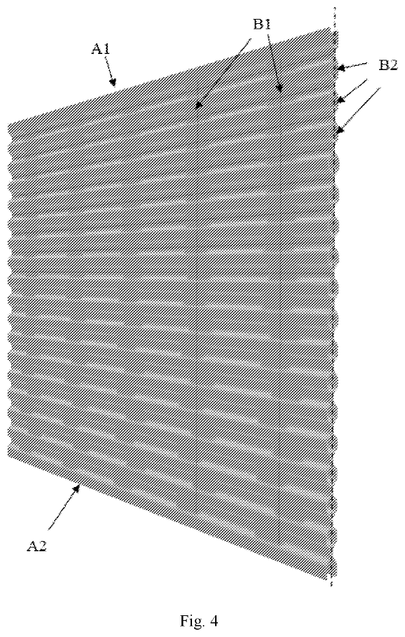

FIGS. 1-4 and 7-9 show the fuel cell bipolar plate 1 having two short sides 2, 3 and two long sides A1, A2.

The bipolar plate 1 comprises an anode plate 4 and a cathode plate 5.

The anode plate 4 has an inlet 6 for an anode gas, an outlet 7 for the anode gas, and channels 8 for the anode gas.

The cathode plate 5 has an inlet 9 for a cathode gas, outlets 10 and channels 11 for the cathode gas.

The anode plate 4 also has holes matching the holes 9 and 10, and the cathode plate 5 has holes matching the holes 6 and 7, as can be seen in FIGS. 1, 2 and 6.

The anode plate 4 and the cathode plate 5 are connected to each other so that channels 12 for distribution of a gaseous heat carrier are formed therebetween, the inlets of these channels are near to the edge of a first long side A1 of the bipolar plate, and the outlets of these channels are near to the edge of a second long side A2 of the bipolar plate.

The channels 12 for distribution of a gaseous heat carrier are formed so that, when a gaseous heat carrier is supplied, a time period of its passing through a half of the bipolar plate near to the edge of the first long side A1 is less than a time period of its passing through a half of the bipolar plate near to the edge of the second long side A2 of the bipolar plate.

The channels 12 for distribution of a gaseous heat carrier include B1 channels extending from the edge of the first long side A1 of the bipolar plate to the edge of the second long side A2 of the bipolar plate, and B2 channels communicating with the B1 channels, B2 channels being substantially parallel to the long sides of the bipolar plate.

The B1 channels comprise regions having obstacles made so as to deflect a part of a gaseous heat carrier flow from an initial direction of its movement for passing through the B2 channels, the part of a gaseous heat carrier flow, which is deflected from the initial direction, being increased in the direction toward the edge of the second long side A2 of the bipolar plate.

As can be seen in FIGS. 1, 2, 4, 7, 8, 9, the B1 channels comprise the regions having obstacles, the regions being made so as to form a bending of a gaseous heat carrier flow passing through them, said bending being increased toward the edge of the second long side A2 of the bipolar plate, which results in deflecting a greater part of a cooling air flow from its initial direction for its passing through the B2 channels; as a result, the greater part of the cooling air flow passes through the B2 channels in the second half of the plate in comparison to the first half.

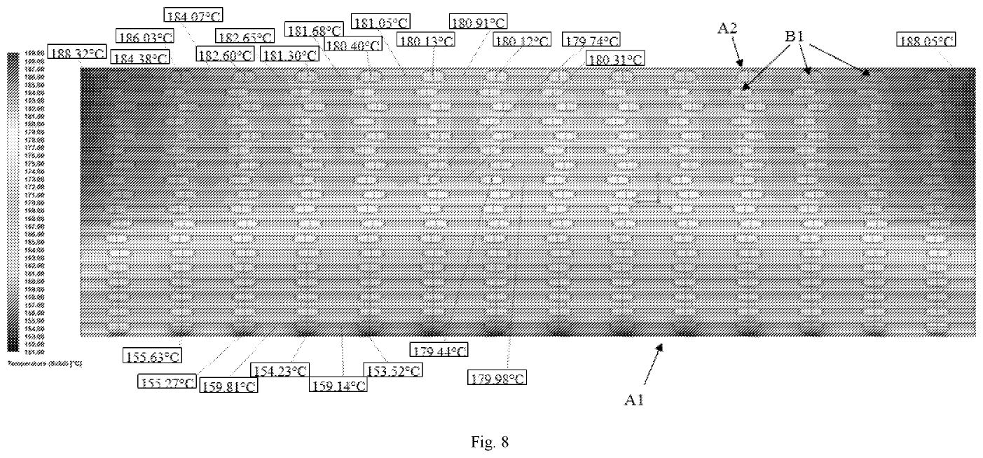

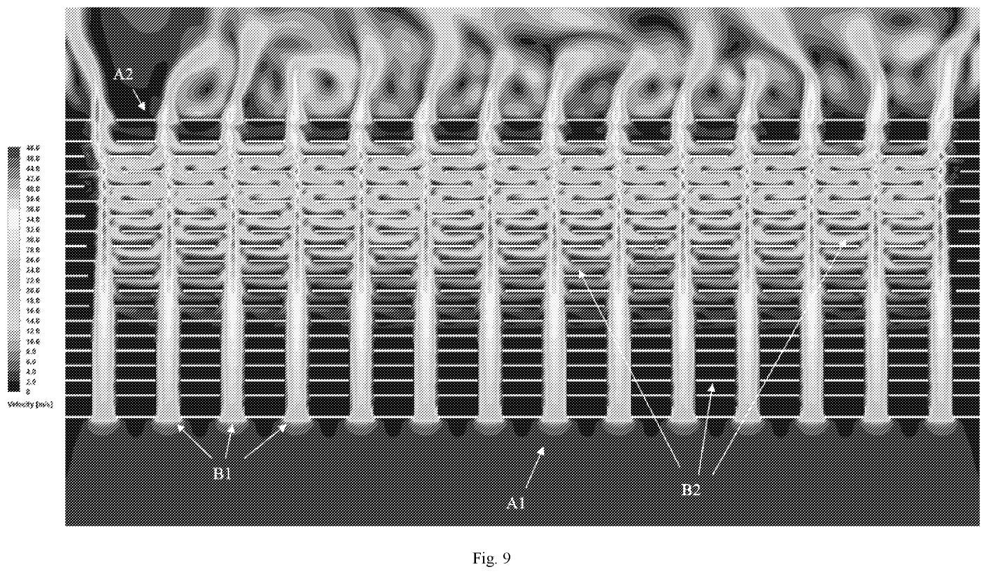

Thus, cooling air may be retained in the second half of the bipolar plate longer, and, as a result, less cold air entering the second half of the plate may remove excess heat due to its longer passage through the second half of the bipolar plate and cool the bipolar plate uniformly, as shown in FIGS. 8 and 9.

### Embodiment 2

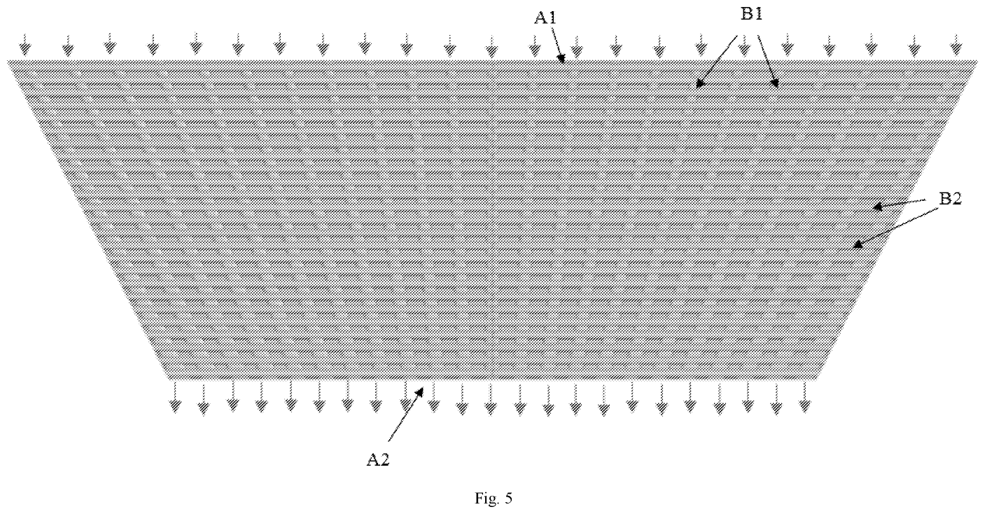

Embodiment 2 of the bipolar plate in accordance with the present invention, as shown in FIG. 5, differs from Embodiment 1 by a trapezoidal shape of the anode plate and the cathode plate as well as by a shape of the B1 channels which cross-sectional area is increased in the direction from the edge of the first long side A1 of the bipolar plate to the edge of the second long side A2 of the bipolar plate.

An increase in the cross-sectional area of the B1 channels as a gaseous heat carrier flow passes from one edge of the bipolar plate to the other one enables to slow the heat carrier movement down and, thus, increase heat removal efficiency during cooling air movement and heating in the bipolar plate, and a decrease in a distance between the cooling channels (owing to the trapezoidal shape of the bipolar plate) enables to reduce a heat amount that is to be removed by the heat carrier during its movement.

This helps to achieve great temperature uniformity inside a fuel cell with a considerable temperature gradient, which, as a result, enables to reduce consumption of cooling air and, correspondingly, weight, volume and energy consumption of the cooling system significantly, which is of particular importance for high-capacity fuel cell systems.

### Embodiment 3

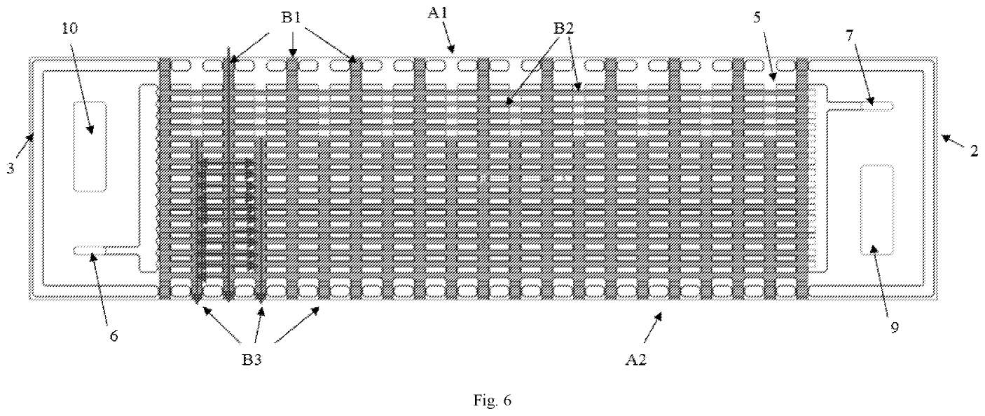

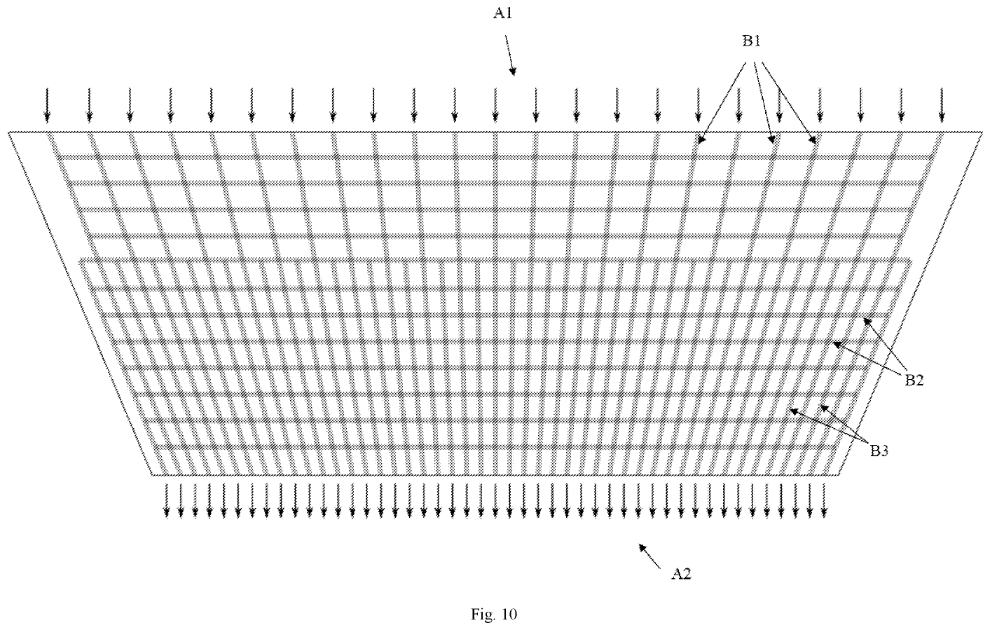

FIGS. 6 and 10 show Embodiment 3 of the bipolar plate in accordance with the present invention.

A fuel cell bipolar plate 1 has two short sides 2, 3 and two long sides A1, A2.

The bipolar plate 1 comprises an anode plate 4 and a cathode plate 5.

The anode plate 4 has an inlet 6 for an anode gas, an outlet 7 for the anode gas, and channels 8 for the anode gas.

The cathode plate 5 has an inlet 9 for a cathode gas, outlets 10 and channels 11 for the cathode gas.

The anode plate 4 also has holes matching the outlets 9 and 10, and the cathode plate 5 has holes matching the inlet 6 and the outlet 7, as can be seen in FIGS. 1, 2 and 6.

The anode plate 4 and the cathode plate 5 are connected to each other so that channels 12 for distribution of a gaseous heat carrier are formed therebetween, the inlets of these channels are near to the edge of a first long side A1 of the bipolar plate, and the outlets of these channels are near to the edge of a second long side A2 of the bipolar plate.

The channels 12 for distribution of a gaseous heat carrier are formed so that, when a gaseous heat carrier is supplied, a time period of its passing through a half of the bipolar plate near to the edge of the first long side A1 is less than a time period of its passing through a half of the bipolar plate near to the edge of the second long side A2 of the bipolar plate.

The channels 12 for distribution of a gaseous heat carrier include B1 channels extending from the edge of the first long side A1 of the bipolar plate to the edge of the second long side A2 of the bipolar plate, and B2 channels communicating with the B1 channels, substantially parallel to the long sides of the bipolar plate.

B3 channels are located between the B1 channels; they have their outlets near the edge of the second long side A2, but do not have their own inlets near the edge of the first long side A1, and the B3 channels are substantially parallel to the short sides of the bipolar plate, the B3 channels communicating to the B1 channels via the B2 channels.

Thus, cooling air may be retained in the second half of the bipolar plate longer, and, as a result, less cold air entering the second half of the plate may remove excess heat due to its longer passage through the second half of the bipolar plate and cool the bipolar plate uniformly.

FIG. 10 shows an example of the bipolar plate portion with a trapezoidal shape of the active surface and increasing number of the longitudinal channels according to Embodiment 3 of the invention.

A decrease in a distance between the cooling channels (owing to the trapezoidal shape of the bipolar plate) enables to reduce a heat amount that is to be removed by the heat carrier during its movement.

According to any of the above embodiments, the bipolar plate can be operated as follows.

A gaseous fuel, e.g. hydrogen, is supplied to the channels 8 for the anode gas; an oxygen-containing mixture, e.g. air, is supplied to the channels 11 for the cathode gas; and a gaseous heat carrier, e.g. air, is supplied to the channels 12 for distribution of a gaseous heat carrier.

The gaseous heat carrier is supplied to the channels 12 for distribution of a gaseous heat carrier at an absolute pressure from 25 kPa to 500 kPa, and a gaseous heat carrier pressure difference on the bipolar plate is from 0.5 to 5 kPa.

### Example 1

An experiment was conducted on the bipolar plate according to Embodiment 1, the bipolar plate comprising cooling channels B1 and B2, a diffuser 13, a confusor 14 and an active area 15.

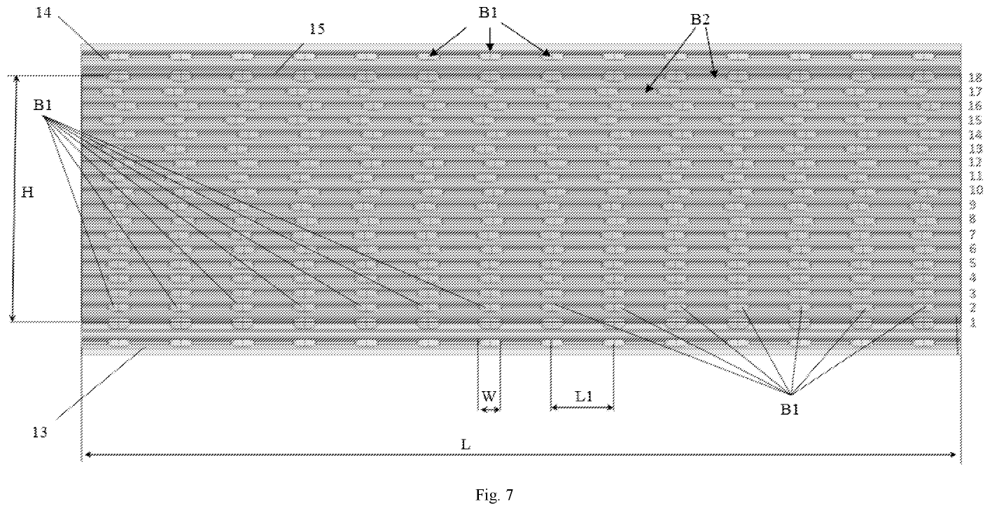

The structure of the bipolar plate active area where heat is removed is shown in FIG. 7 with dimension lines.

The length L of the bipolar plate active area was 250 mm, the distance L1 between the cooling channel inlets was 17.6 mm, the width W of the cooling channel inlets was 6 mm, the width H of the active area was 70 mm.

| | Deflection of B1 channels from the |
|---|---|
| Row | longitudinal axis |
| 1 | 0 |
| 2 | 0 |
| 3 | 0 |
| 4 | 0 |
| 5 | 0.175 |
| 6 | 0.350 |
| 7 | 0.525 |
| 8 | 0.700 |
| 9 | 0.875 |
| 10 | 1.050 |
| 11 | 1.225 |
| 12 | 1.400 |
| 13 | 1.575 |
| 14 | 1.750 |
| 15 | 1.925 |
| 16 | 1.925 |
| 17 | 1.925 |
| 18 | 0 |

Cooling air at the absolute pressure of 101 kPa was supplied to the channels 12 for distribution of a gaseous heat carrier.

The cooling air pressure difference on the bipolar plate was 2.5 kPa.

The cooling air flowrate was 1.61 g/s.

The cooling air maximum velocity was 46.8 m/s.

The cooling air temperature at the inlet was +55° C.

The total heat generation by the fuel cell was 195 W with uniform distribution along the active area.

The plate material was aluminium.

The maximum temperature of the bipolar plate in the active area was tₘₐₓ=189° C.

The minimal temperature of the bipolar plate in the active area was tₘᵢₙ=152° C.

The average bulk temperature of the bipolar plate in the active area was t_{avg}=176° C.

FIG. 8 shows temperature distribution during the process of heat generation by the fuel cell and heat rejection by cooling air passing through the bipolar plate.

FIG. 9 shows the path of the cooling air flow in the bipolar plate.

Thus, the use of the present invention enabled to improve uniformity of cooling (or heating) of the bipolar plate, which resulted in prolonging its service life, reducing consumption of cooling (or heating) air and decreasing power consumption, weight and dimensions of the cooling (heating) system of the fuel cell.

The above-described embodiments are provided for illustrative purposes only. A person skilled in the art will appreciate that other embodiments of the invention are possible, but without changing the essence of the invention.

1. A fuel cell bipolar plate having two short sides and two long sides and comprising:
an anode plate having an inlet for anode gas, an outlet for anode gas and anode gas channels;
a cathode plate having an inlet for cathode gas, an outlet for cathode gas and cathode gas channels;
wherein the anode gas channels are made in such a manner that the inlet for anode gas is near an edge of one short side of the bipolar plate, and the outlet for anode gas is near an edge of the other short side of the bipolar plate;
wherein the cathode gas channels are made in such a manner that the inlet for cathode gas is near the edge of one short side of the bipolar plate, and the outlet for cathode gas is near the edge of the other short side of the bipolar plate;
wherein the anode plate and the cathode plate are connected to each other in such a manner that gaseous heat carrier distribution channels are formed therebetween, the gaseous heat carrier distribution channels having inlets near an edge of a first long side A1 of the bipolar plate and outlets near an edge of a second long side A2 of the bipolar plate; and
wherein the gaseous heat carrier distribution channels are formed in such a manner that, when a gaseous heat carrier is supplied, a time period for which the gaseous heat carrier passes a half of the bipolar plate near to the edge of the first long side A1 is less than a time period for which the gaseous heat carrier passes a half of the bipolar plate near to the edge of the second long side A2 of the bipolar plate.

2. The fuel cell bipolar plate of claim 1, characterized in that the bipolar plate has a substantially rectangular shape, trapezoidal shape or a shape of a ring sector.

3. The fuel cell bipolar plate of claim 1, characterized in that the gaseous heat carrier distribution channels include B1 channels extending from the edge of the first long side A1 of the bipolar plate to the edge of the second long side A2 of the bipolar plate, and B2 channels communicating with B1 channels, wherein B2 channels are substantially parallel to the long sides of the bipolar plate.

4. The fuel cell bipolar plate of claim 3, characterized in that a cross-sectional area of the B1 channels is increased in the direction from the edge of the first long side A1 of the bipolar plate to the edge of the second long side A2 of the bipolar plate.

5. The fuel cell bipolar plate of claim 3, characterized in that the B1 channels comprise regions having obstacles made so as to deflect a part of a gaseous heat carrier flow from an initial direction of its movement for passing through the B2 channels, wherein the part of the gaseous heat carrier flow, which is deflected from the initial direction, is increased in the direction toward the edge of the second long side A2 of the bipolar plate.

6. The fuel cell bipolar plate of claim 5, characterized in that said regions are made so as to form a deflection of the part of a gaseous heat carrier flow from an initial direction of its movement, wherein the deflection is increased toward the edge of the second long side A2 of the bipolar plate.

7. The fuel cell bipolar plate of claim 3, characterized in that B3 channels are located between the B1 channels, having their outlets near the edge of the second long side A2 of the bipolar plate, but not having their own inlets near the edge of the first long side A1 of the bipolar plate, and being substantially parallel to the short sides of the bipolar plate, the B3 channels communicating to the B1 channels via the B2 channels.

8. The fuel cell bipolar plate of claim 7, characterized in that a cross-sectional area of the B3 channels is increased toward the edge of the second long side A2 of the bipolar plate.

9. The fuel cell bipolar plate of claim 3, characterized in that a distance between the B1 channels is decreased in the direction from the edge of the first long side A1 of the bipolar plate to the edge of the second long side A2 of the bipolar plate, wherein the bipolar plate has a substantially trapezoidal shape or a shape of a ring sector.

10. The fuel cell bipolar plate of claim 3, characterized in that inserts are arranged in the B1 channels, wherein the inserts prevent at least a part of a gaseous heat carrier flow from passing through the B2 channels in the half of the bipolar plate near to the edge of the first long side A1.

11. The fuel cell bipolar plate of claim 1, characterized in that the anode plate and the cathode plate are made of a material having heat conductivity of at least 100 W/(m K), wherein the material is selected from the group consisting of aluminium, magnesium, beryllium alloys, and composite materials based on graphite films, carbon fibers or graphene.

12. A method for operating the bipolar plate of claim 1, wherein a gaseous fuel is supplied to the anode gas channels; an oxygen-containing mixture is supplied to the cathode gas channels; and a gaseous heat carrier is supplied to the gaseous heat carrier distribution channels.

13. The method of claim 12, characterized in that a gaseous heat carrier is supplied to the gaseous heat carrier distribution channels under an absolute pressure between about 25 kPa and about 500 kPa; and a gaseous heat carrier pressure difference on the bipolar plate is between about 0.5 and about 5 kPa.
